(19) United States
(12) Patent Application Publication
(10) Pub. No.: US 2026/0259246 A1
(43) Pub. Date: Sep. 3, 2026

(54) METHOD FOR OPERATING AN INERTIAL MEASUREMENT UNIT AND INERTIAL MEASUREMENT UNIT

(71) Applicant: Robert Bosch GmbH, Stuttgart (DE)

(72) Inventor: Ossi Mäenpää, Espoo (FI)

(21) Appl. No.: 19/549,034

(22) Filed: Feb. 25, 2026

(30) Foreign Application Priority Data
Mar. 3, 2025 (DE) 10 2025 107 922.6

(51) Int. Cl. G01P 15/097; G01P 15/18

(52) U.S. Cl. CPC G01P 15/097; G01P 15/18

(57) ABSTRACT

A computer-implemented method for operating an inertial measurement unit in an electronic device. The electronic device include a first vibration-generating component and a second vibration-generating component. The inertial measurement unit includes an inertial sensor assembly and a filter system. The method includes: receiving first feedback data of the first component and second feedback data of the second component by the filter system, wherein the feedback data are data of a control loop that is regulating the respective component; receiving sensor data of the inertial sensor assembly by the filter system; and filtering first vibration components generated by the first component and/or second vibration components generated by the second component out of the sensor data of the inertial sensor assembly and generating filtered sensor data by the filter system.

### CROSS REFERENCE

The present application claims the benefit under 35 U.S.C. § 119 of Germany Patent Application No. DE 10 2025 107 922.6 filed on March 3, 2025, which is expressly incorporated herein by reference in its entirety.

### FIELD

The present disclosure related to a method for operating an inertial measurement unit and inertial measurement unit.

### BACKGROUND INFORMATION

Certain inertial measurement units (IMUs) and corresponding methods for operating such inertial measurement units are described in the related art.

It is an object of the present disclosure to provide an improved method for operating an inertial measurement unit and an improved inertial measurement unit.

### SUMMARY

The object may be achieved by a method and an inertial measurement unit having certain features of the present disclosure. Advantageous embodiments are disclosed herein.

According to one aspect of the present disclosure, a computer-implemented method for operating an inertial measurement unit in an electronic device is provided. The electronic device includes at least a first vibration-generating component and a second vibration-generating component, wherein the inertial measurement unit comprises an inertial sensor assembly and a filter system, wherein the filter system comprises an adaptive filter. According to an example embodiment, the method comprises: receiving, by the filter system, first feedback data of the first component and second feedback data of the second component, wherein the feedback data are data of a control loop regulating the respective component;

receiving, by the filter system, sensor data of the inertial sensor assembly; and

filtering first vibration components generated by the first component and/or second vibration components generated by the second component out of the sensor data of the inertial sensor assembly and generating filtered sensor data by the filter system.

As a result, the technical advantage can be achieved that an improved method for operating an inertial measurement unit in an electronic device can be provided.

According to an example embodiment, the inertial measurement unit comprises an inertial sensor assembly for providing sensor data and a filter system for filtering the provided sensor data. Here, the filter system is configured to filter the sensor data of the inertial sensor assembly for vibration components of the electrically operable and vibration-generating components of the electronic device. For this purpose, the filter system is configured to receive feedback data of the at least two different vibration-generating components and, based thereon, to filter the different vibration components of the at least two components out of the sensor data of the inertial sensor assembly and to provide filtered sensor data.

The inertial measurement unit can be used, for example, in an electronic device designed as a mobile device, for example a mobile phone or tablet or smartwatch. The various components can be vibration-generating components, such as, for example, loudspeakers or vibration alarms.

By means of the corresponding filter system, the sensor data of the inertial sensor assembly can be efficiently filtered for the vibrations generated by the various components. As a result, the measurement accuracy of the inertial measurement unit can be increased.

An inertial measurement unit within the meaning of the application is an inertial measurement unit IMU. The inertial sensor assembly within the meaning of the application comprises at least one inertial sensor.

By the filter system comprising an adaptive filter element, a high-performance filter system can be provided.

According to one example embodiment, the filter system comprises a preprocessing module for preprocessing the feedback data and at least one filter element for performing the filtering, wherein the receiving of the first and second feedback data is handled by the preprocessing module. According to an example embodiment, the method further comprises:

adapting a gain factor of the first feedback data and of the second feedback data and adapting vibration strengths of the vibrations of the first and second components to a predefined gain factor by the preprocessing module; and/or

adapting first and second vibration directions to sensor axes of the inertial sensor assembly by the preprocessing module; and/or adapting sampling rates of the first feedback data and of the second feedback data to a predefined sampling rate by the preprocessing module.

As a result, the technical advantage can be achieved that, by means of the preprocessing module, the feedback data originating from the various components of the respective control loops regulating the components can be adapted to a predefined format. As a result, the simplified processing of the feedback data of the various components by the filter system is made possible.

Since the components are different types of devices, the feedback data can be based on different sampling frequencies. Moreover, the vibrations generated by the various components can have different vibration strengths and vibration directions.

Due to the corresponding adaptations, they can be brought into a common format, so that simplified processing by the filter system is made possible.

According to one example embodiment, the method further comprises:

ascertaining, by the preprocessing module, the vibrations of the first component as dominant vibrations on the basis of the first and second feedback data; and

prioritized filtering of the dominant vibrations by the at least one filter element.

As a result, the technical advantage can be achieved that, due to prioritized filtering exclusively of the dominant vibrations, the filtering process can be simplified. As a result, computing capacity can be saved.

According to one example embodiment, the first component and the second component are two different electrically operable components from the following list: loudspeaker, optical stabilization element of a camera module, haptic actuator, vibration alarm system.

As a result, the technical advantage can be achieved that, due to the filter system, vibrations of vibration-generating components customary in mobile devices can be filtered out of the sensor data of the inertial measurement unit. In particular, when the inertial measurement unit is used in such mobile devices, an improvement in measurement accuracy can thus be achieved.

According to one example embodiment, the method further comprises:

ascertaining, by the preprocessing module, a first vibration direction of the vibrations of the first component on the basis of the first feedback data and/or ascertaining a second vibration direction of the vibrations of the second component on the basis of the second feedback data, and/or wherein the filtering of the sensor data comprises:

filtering out of the sensor data the first vibration components and/or second vibration components for a selected spatial direction.

As a result, the technical advantage can be achieved that, according to the application, the filtering of the vibrations can be carried out in a directionally bound manner. Depending on the application of the inertial measurement unit, by selecting the vibration directions and restricting filtering to the selected vibration directions, the filter method can in turn be simplified.

According to one example embodiment, the filter system comprises a first filter element and a second filter element, wherein the filtering of the first vibration components is carried out by the first filter element and the filtering of the second vibration components is carried out by the second filter element.

As a result, the technical advantage can be achieved that, by means of the first and second filter elements, which are configured for this, in each case the first vibration components of the first component or the second vibration components of the second component can be filtered.

According to one aspect of the present disclosure, an inertial measurement unit with active noise suppression is provided, wherein the inertial measurement unit comprises an inertial sensor assembly and a filter system with a preprocessing module and at least one adaptive filter element, and wherein the inertial measurement unit is configured to carry out the method for operating an inertial measurement unit according to one of the above-described embodiments.

As a result, the technical advantage can be achieved that an improved inertial measurement unit can be provided, which is configured to carry out the method according to the present disclosure with the above technical advantages.

According to one example embodiment, the inertial measurement unit further comprises an ASIC, wherein the preprocessing module and/or the filter element are installed and can be implemented on the ASIC, and/or wherein the filter element is designed as an adaptive LMS FIR filter, and/or wherein the at least one filter element comprises at least one trained artificial intelligence.

As a result, the technical advantage can be achieved that, due to the ASIC, the preprocessing module and/or the filter element can be implemented directly in the inertial measurement unit. For this reason, additional computing capacity is not required. By designing the filter element as an adaptive LMS FIR filter, a high-performance filter element can be provided. Due to the appropriately trained artificial intelligence, a high-performance adaptive filter element can be provided.

According to one aspect of the present disclosure, a computing unit is provided which is configured to carry out the method for operating an inertial measurement unit according to one of the above-described embodiments.

According to one aspect of the present disclosure, a computer program product comprising commands is provided that, when the program is executed by a data processing unit, cause the data processing unit to carry out the method for operating an inertial measurement unit according to one of the above-described embodiments.

Embodiments of the present disclosure are described with reference to the figures.

### BRIEF DESCRIPTION OF THE DRAWINGS

FIG. 1 is a schematic representation of an inertial measurement unit according to one embodiment;

FIG. 2 is a further schematic representation of the inertial measurement unit according to a further embodiment;

FIG. 3 is a flowchart of a method for operating an inertial measurement unit according to one embodiment;

FIG. 4 is a further flowchart of the method for operating an inertial measurement unit according to a further embodiment; and

FIG. 5 is a schematic representation of a computer program product.

### DETAILED DESCRIPTION OF EXAMPLE EMBODIMENTS

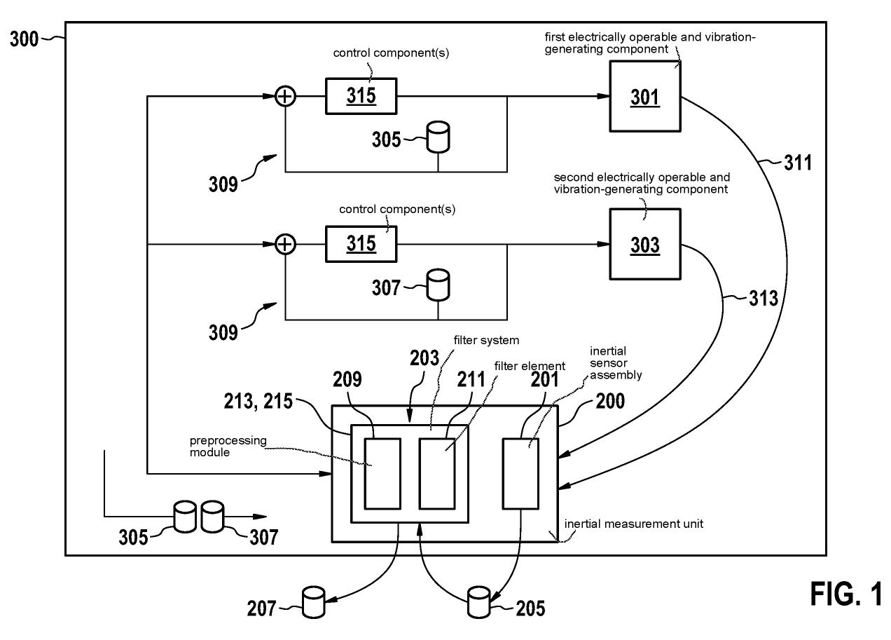

FIG. 1 shows an inertial measurement unit 200 according to the present disclosure. In FIG. 1 the inertial measurement unit 200 is shown installed in an electronic device 300.

According to the present disclosure, the inertial measurement unit 200 comprises an inertial sensor assembly 201 and a filter system 203.

The inertial sensor assembly 201 comprises at least one inertial sensor. The inertial sensor assembly 201 can be designed, for example, as a three-axis or six-axis inertial sensor, or as a three-axis acceleration sensor or as a combination of a three-axis acceleration sensor and a three-axis inertial sensor. The filter system 203 comprises, according to the present disclosure, an adaptive filter and is configured to perform the filtering of the sensor data 205 of the inertial measurement unit 200.

In the embodiment shown, the filter system 203 comprises a preprocessing module 209 and at least one filter element 211. The filter element 211 is designed as an adaptive filter. According to one embodiment, the filter element 211 can be designed as an adaptive LMS FIR filter (finite impulse response filter with a least mean squares algorithm).

In the embodiment shown, the inertial measurement unit comprises an ASIC 213 or a computing unit 215, on which the filter system 203 is installed and can be implemented.

In the embodiment shown, the electronic device 300 comprises a first electrically operable and vibration-generating component 301 and a second electrically operable and vibration-generating component 303.

The first and second components 301, 303 in each case are operated via a control loop 309 with control components 315 customary for control loops and from the related art.

According to the present disclosure, the filter system 203 is now configured, on the basis of first feedback data 305 of the control loop 309 of the first component 301 and on the basis of second feedback data 307 of the control loop 309 of the second component 303, to filter first vibration components 311 of the first component 301 and/or second vibration components 313 of the second component 303 out of the sensor data 205 of the inertial sensor assembly 201 and to provide corresponding filtered sensor data 209.

According to one embodiment, the first and second components 301, 303 are two different types of electrically operable components from the following list: loudspeaker, optical stabilization element of a camera module, haptic feedback actuator for a touch-sensitive display, vibration alarm system. The mentioned types of components are customary components in a mobile device, for example a mobile phone, and generate vibrations of different vibration modes during operation.

The vibrations of the various components 301, 303 correspondingly transmitted in the device 300 can negatively influence the measurements of the inertial sensor assembly 201 of the inertial measurement unit 200. Due to the filter system 203 with the at least one filter element 211 designed as an adaptive filter, the efficient and precise cleaning of the sensor data 205 of the inertial sensor assembly 201 with regard to the various vibration components 311, 313 can be effected.

According to one embodiment, the preprocessing module is configured to adapt sampling rates of the first and second feedback data 305, 307 of the first and second components 301, 303 to a predefined sampling rate. By adapting the sampling rates, the feedback data of the different components 301, 303, which in each case are designed as different types of components, can be adapted to a predefined form, so that they can be uniformly taken into account by the filter element 211.

According to one embodiment, the preprocessing module 209 is further configured to adapt gain factors of the first and second feedback data 305, 307 and vibration strengths of the vibrations of the first and second components to a predefined gain factor.

The preprocessing module 209 is configured to read and process any data formats of the various feedback data 305, 307 of the various components 301, 303.

Since the various components 301, 303 have different component types and thus generate different types of vibration modes, the first and second vibration components 311, 313 of the first and second components 301, 303 have different vibration strengths.

By adapting the gain factor representing the vibration strengths of the first and second feedback data 305, 307 to a predefined gain factor, the feedback data 305, 307 can in turn be brought into a general format. As a result, processing of the feedback data 305, 307 by the filter element 211 is improved.

According to one embodiment, the preprocessing module is further configured to adapt vibration directions of the first and second vibration components 311, 313 on the basis of the first and second feedback data 305, 307 to a predefined vibration direction.

As a result, the vibration directions can be adapted to the orientation of the channels of the inertial sensor assembly 201, whereby improved correction of the sensor data 205 by the filter element 211 is made possible.

According to one embodiment, the preprocessing module 209 further ascertains, on the basis of the first and second feedback data 305, 307, vibrations of the first component 301 or of the second component 303 as dominant vibrations. Following this, the filter element 211 can, in a prioritized manner, filter the first or second vibration components 311, 313 of the first or second component 301, 303 ascertained to be dominant vibrations.

According to one embodiment, the preprocessing module 209 ascertains, on the basis of the first and second feedback data 305, 309, the vibration directions of the first and second vibration components 311, 313 of the first and second components 301, 303.

The filter element 211 can subsequently restrict the filtering process of the sensor data 205 of the inertial sensor assembly 201 with regard to a predefined vibration direction. The filter system 203 is thus capable of performing the filtering process of the sensor data 205 in a directionally bound manner.

According to one embodiment, the filter system 203 can comprise a plurality of filter elements 211. Here, the plurality of filter elements 211 in each case are configured to filter a vibration component 311, 313 of one of the plurality of components 301, 303.

According to one embodiment, the filter element 211 comprises an artificial intelligence, in particular an artificial neural network. Here, the training of the filter element 211 can be carried out upon installation of the inertial measurement unit 200 in the respective electronic device 300 on the basis of the respective feedback data 305, 307 and the vibration components 311, 313 of the respective components 301, 303.

According to one embodiment, the preprocessing module 209 can be implemented in a central processing unit, not shown in FIG. 1, of the electronic device 300.

According to one embodiment, the filter element 211 can be implemented in the central processor unit of the electronic device 300.

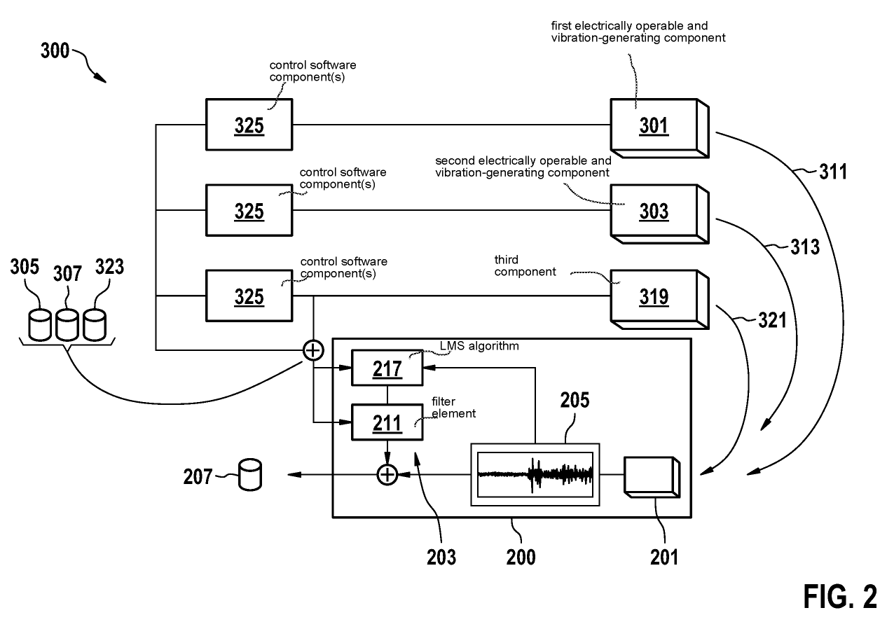

The embodiment in FIG. 2 is based on the embodiment in FIG. 1 and includes all of the features described there.

In FIG. 2, the electronic device 300 is shown in simplified form.

In the embodiment shown, the electronic device 300 further comprises a third component 319. The third component 319 correspondingly generates a third vibration component 321, which acts on the measurements of the inertial sensor assembly 201.

In FIG. 2, control software components 325 of the three different components 301, 303, 319 are further shown.

According to the embodiment in FIG. 2, the filter system 203 is configured, on the basis of the feedback data 305, 307, 323 of the three different components 301, 303, 313, to perform the filtering of the sensor data 205 of the inertial sensor assembly 201 with regard to the first to third vibration components 311, 313, 321.

In the embodiment shown, the filter system 203 further comprises an LMS algorithm 217. The LMS algorithm 217 is part of a conventional adaptive filter element and comprises all properties from the related art.

In FIG. 2, for reasons of clarity, the preprocessing module 209 of the filter system 200 is not shown.

According to the present disclosure, the filter system 203 of the inertial measurement unit 200 of the present disclosure can be configured to filter vibration components of any number of different vibration-generating components 301, 303, 321 of an electronic device 300, for example a mobile phone or tablet, out of the sensor data 205 of the inertial sensor assembly 201.

For operating the inertial measurement unit, in a first method step 101 first feedback data 305 of the first component 301 and second feedback data 307 of the second component 303 are received by the filter system 203.

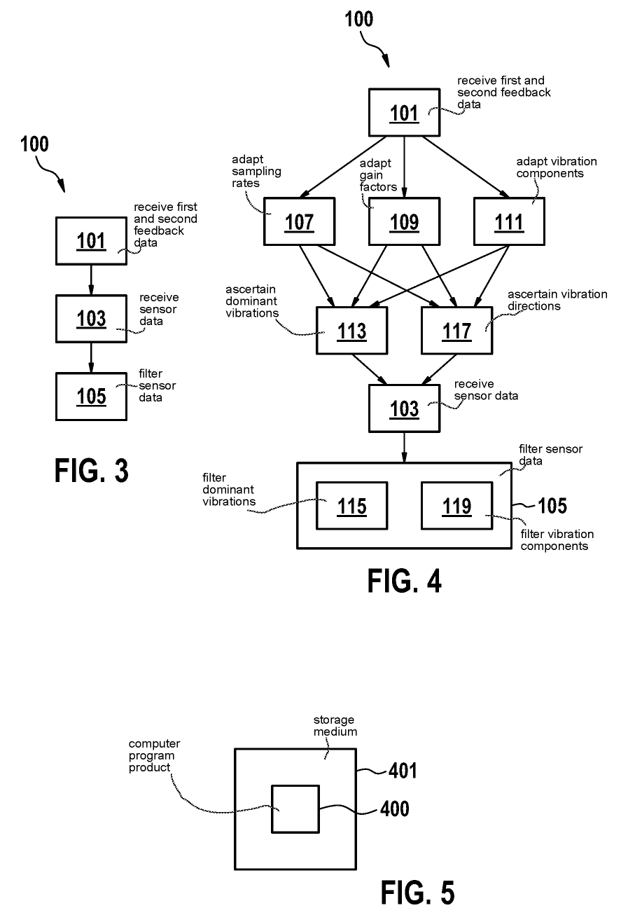

FIG. 3 shows a flowchart of a method 100 for operating an inertial measurement unit 200 according to a further embodiment.

In a further method step 103, the sensor data 205 of the inertial sensor assembly 201 are received by the filter system 203.

In a further method step 105, the sensor data 205 of the inertial sensor assembly 201 are filtered with regard to the first vibration components 311 and/or the second vibration components 313 of the first and second components 301, 303, and filtered sensor data 207 are provided.

FIG. 4 shows a further flowchart of the method 100 for operating an inertial measurement unit 200 according to a further embodiment.

In the embodiment shown, in a further method step 107, sampling rates of the first and second feedback data 305, 307 are adapted to a predefined sampling rate by the preprocessing module 209.

Alternatively or additionally, in a method step 109, gain factors of the first and second feedback data 305, 307 are adapted by the preprocessing module 209.

Alternatively or additionally, in a method step 111, the vibration directions of the first and second vibration components 311, 313 are adapted by the preprocessing module 209.

In a further method step 113, dominant vibrations are ascertained by the preprocessing module 209 on the basis of the feedback data 305, 307.

When the dominant vibrations are being ascertained, in a further method step 115, the dominant vibrations are filtered in a prioritized manner by the filter element 211.

Alternatively or additionally, in a method step 117, vibration directions of the first and second vibration components 311, 313 are ascertained by the preprocessing module 209.

In this case, in a further method step 119, the vibration components 311, 313 are filtered in a directionally bound manner by the filter element 211.

FIG. 5 shows a schematic representation of a computer program product 400 comprising commands that, when the program is executed by a data processing unit, cause the latter to carry out the method 100 for operating an inertial measurement unit 200.

In the embodiment shown, the computer program product 400 is stored on a storage medium 401. The storage medium 401 can be any storage medium from the related art.

What is claimed is:

1. A computer-implemented method for operating an inertial measurement unit in an electronic device, the electronic device includes a first vibration-generating component and a second vibration-generating component, wherein the inertial measurement unit includes an inertial sensor assembly and a filter system, wherein the filter system includes an adaptive filter, the method comprising the following steps:
receiving first feedback data of the first component and second feedback data of the second component by the filter system, wherein the first and second feedback data are data of a control loop that is respectively regulating the first and second component;
receiving sensor data of the inertial sensor assembly by the filter system; and
filtering first vibration components generated by the first component and/or second vibration components generated by the second component out of the sensor data of the inertial sensor assembly and generating filtered sensor data by the filter system.

2. The method according to claim 1, wherein the filter system includes a preprocessing module configured to preprocess the first and second feedback data and at least one filter element configured to carry out the filtering, wherein the receiving of the first and second feedback data is handled by the preprocessing module, and wherein the method further comprises at least one of:
adapting sampling rates of the first feedback data and of the second feedback data to a predefined sampling rate by the preprocessing module; or
adapting gain factors of the first feedback data and of the second feedback data and adapting vibration strengths of vibrations of the first and second components to a predefined gain factor by the preprocessing module; or
adapting first and second vibration directions to sensor axes of the inertial sensor assembly by the preprocessing module.

3. The method according to claim 2, further comprising:
ascertaining the vibrations of the first component or the vibrations of the second component as dominant vibrations based on the first and second feedback data by the preprocessing module; and
prioritized filtering of the dominant vibrations by the at least one filter element.

4. The method according to claim 1, wherein the first component and the second component are two different electrically operable components from the following list: loudspeaker, optical stabilization element of a camera module, haptic actuator, vibration alarm system.

5. The method according to claim 1, wherein at least one of:
the method further comprises ascertaining a first vibration direction of vibrations of the first component based on the first feedback data, of
the method further comprises ascertaining a second vibration direction of vibrations of the second component based on the second feedback data by the preprocessing module, or
the filtering of the sensor data includes:
filtering the first vibration components and/or the second vibration components for a selected spatial direction out of the sensor data.

6. The method according to claim 1, wherein the filter system includes a first filter element and a second filter element, wherein the filtering of the first vibration components is carried out by the first filter element and the filtering of the second vibration components is carried out by the second filter element.

7. An inertial measurement unit with active noise suppression, wherein the inertial measurement unit comprises:
an inertial sensor assembly; and
a filter system including a preprocessing module and at least one adaptive filter element;
wherein the inertial measurement unit is configured to operate the inertial measurement unit in an electronic device, the electronic device includes a first vibration-generating component and a second vibration-generating component, wherein the inertial measurement unit includes an inertial sensor assembly and a filter system, wherein the filter system includes an adaptive filter, and wherein the inertial measurement component performs the steps including:
receiving first feedback data of the first component and second feedback data of the second component by the filter system, wherein the first and second feedback data are data of a control loop that is respectively regulating the first and second component,
receiving sensor data of the inertial sensor assembly by the filter system, and
filtering first vibration components generated by the first component and/or second vibration components generated by the second component out of the sensor data of the inertial sensor assembly and generating filtered sensor data by the filter system.

8. The inertial measurement unit according to claim 7, wherein at least one of:
the inertial measurement unit further comprises an ASIC, and wherein the preprocessing module and/or the at least one filter element are installed or implemented on the ASIC, or
the at least one filter element includes an adaptive LMS FIR filter, or
the at least one filter element includes at least one trained artificial intelligence.

9. A computing unit configured to operate an inertial measurement unit in an electronic device, the electronic device includes a first vibration-generating component and a second vibration-generating component, wherein the inertial measurement unit includes an inertial sensor assembly and a filter system, wherein the filter system includes an adaptive filter, the computer unit configured to perform the following steps including:
receiving first feedback data of the first component and second feedback data of the second component by the filter system, wherein the first and second feedback data are data of a control loop that is respectively regulating the first and second component;
receiving sensor data of the inertial sensor assembly by the filter system; and
filtering first vibration components generated by the first component and/or second vibration components generated by the second component out of the sensor data of the inertial sensor assembly and generating filtered sensor data by the filter system.

10. A non-transitory computer-readable medium on which is stored a computer program including commands for operating an inertial measurement unit in an electronic device, the electronic device includes a first vibration-generating component and a second vibration-generating component, wherein the inertial measurement unit includes an inertial sensor assembly and a filter system, wherein the filter system includes an adaptive filter, the commands, when executed by a data processor, causing the data processor to perform the following steps:
receiving first feedback data of the first component and second feedback data of the second component by the filter system, wherein the first and second feedback data are data of a control loop that is respectively regulating the first and second component;
receiving sensor data of the inertial sensor assembly by the filter system; and
filtering first vibration components generated by the first component and/or second vibration components generated by the second component out of the sensor data of the inertial sensor assembly and generating filtered sensor data by the filter system.
